(19) United States
(12) Patent Application Publication
(10) Pub. No.: US 2024/0278647 A1
(43) Pub. Date: Aug. 22, 2024

(54) Method for Braking a Motorcycle and Electrically Driven Motorcycle

(71) Applicant: Bayerische Motoren Werke Aktiengesellschaft, Muenchen (DE)

(72) Inventors: Kenneth BENATH CAMARA, Muenchen (DE); Florian HUELSMANN, Muenchen (DE); Anton MAYER, Scheyern (DE); Hanno ROTHENARI, Unterschleissheim (DE)

(21) Appl. No.: 18/292,602

(22) PCT Filed: Jun. 8, 2022
(86) PCT No.: PCT/EP2022/065557

§ 371 Date: Jan. 26, 2024

(30) Foreign Application Priority Data
Jul. 28, 2021 (DE) 10 2021 119 516.0

(51) Int. Cl. B60L 7/24; B60L 7/14; B60L 7/28

(52) U.S. Cl. CPC B60L 7/24; B60L 7/14; B60L 7/28; B60L 2200/12

(57) ABSTRACT

An electrically driven motorcycle includes a drive energy store, an on-board electrical system, a motor, a braking device, and a control unit. A method to brake the motorcycle includes detecting currently required braking torque, current maximum charge power of the drive energy store, current maximum power loss that can be generated in the motor and/or on-board electrical system, currently required power loss resulting from a difference in current maximum charge power and maximum power recovery of the motor for the required braking torque, and an additional braking device braking torque resulting from a difference in required braking torque and motor braking torque resulting from the current maximum charge power and the current maximum power loss that can be applied, and controlling the motor and/or the on-board electrical system with reduced efficiency such that the required power loss is achieved, and actuating the braking device to apply the additional braking torque.

### BACKGROUND AND SUMMARY

The invention relates to a method for braking an electrically driven motorcycle and to an electrically driven motorcycle.

In electrically driven vehicles, the electrical drive motor for decelerating the vehicle can be operated as a generator, wherein part of the kinetic energy of the vehicle is recovered as electrical energy and fed into the drive energy store. This process is referred to as recuperation.

If the drive system, in particular the electrical drive motor and the drive energy store, are of sufficiently powerful design, it is possible in most situations to brake the vehicle exclusively by way of a deceleration effect on the driven axle by means of the electrical drive motor.

However, the present maximum charging power at each point in time, which is influenced by the present free charging capacity of the drive energy store, inter alia, limits the braking power since this predetermines the maximum permitted magnitude of the electrical power generated during the recuperation process. The electrical power generated is in turn proportional to the braking torque that can be applied.

It is an object of the invention to provide an improved braking method for an electrically driven motorcycle which is based on a recuperation process.

This object is achieved by a method for braking an electrically driven motorcycle comprising a drive energy store, an onboard electrical system connected to the drive energy store, an electrical drive motor that is usable as a generator, and at least one additional braking device that is separate from the electrical drive motor. The method involves detecting a braking intention with a presently required braking torque. A present maximum charging power of the drive energy store is determined. Moreover, a present maximum power loss that is generable in the electrical drive motor and/or in the onboard electrical system is determined. A presently required power loss is determined, resulting from a difference between the present maximum charging power and a maximum recuperation power of the electrical drive motor for the presently required braking torque. A present additional braking torque is determined which is to be applied by the additional braking device and which results from a difference between the presently required braking torque and a braking torque of the electrical drive motor resulting from the present maximum charging power and the present maximum power loss that can be applied. The electrical drive motor and/or the onboard electrical system are/is controlled with a reduced efficiency such that the presently required power loss is attained. Moreover, the additional braking device is actuated such that the present additional braking torque is applied by the additional braking device.

One aim of the invention, in a multistage process, is to reduce the electrical current which is generated during the braking process and which is fed to the drive energy store as charging current, with maintenance of the highest possible braking torque by the electrical drive motor, in the case in which only a low maximum charging power of the drive energy store is available. The maximum recuperation power in relation to the presently required braking torque is always considered in this case.

Instead of the entire current generated by the electrical drive motor being fed to the drive energy store as charging current, in the event of insufficient charging power, the electrical drive motor and/or the onboard system are/is operated such that as much electrical current as possible is consumed as power loss in the vehicle.

In a further step, if these measures are insufficient and the present maximum charging power is insufficient despite application of the maximum power loss that can presently be applied, the remaining braking torque is applied by the additional braking device, the braking effect of which is independent of the charging power of the drive energy store.

In this way, it is ensured that every braking intention on the part of the driver at any point in time is able to be fulfilled independently of the present maximum charging power of the drive energy store.

The charging of the drive energy store takes precedence here. As long as the present maximum charging power of the drive energy store is sufficient to take up the recuperation current generated by the electrical drive motor at maximum efficiency, it is not necessary to reduce the efficiency of the electrical drive motor or other components or to generate further power loss in some other way in the onboard system. The use of the additional braking device is also dispensed with in just the same way. Maximally effective recuperation during braking processes is therefore always ensured. The presently required power loss and the present additional braking torque are equal to zero in such a case.

In general, the method is directed to minimizing the present additional braking torque applied by the additional braking device in order that the additional braking device is used as little as possible. This has the advantages that the additional braking device can be designed with a relatively low power and, moreover, little wear occurs owing to the little use.

In general, the recuperation power is proportional to the product of braking torque, efficiency and rotational speed of the electric motor, which is in turn proportional to a present driving speed. The present maximum charging power is proportional to the product of the present voltage at the drive energy store and the present maximum charging current of the drive energy store, there being a temperature dependence as well here, inter alia.

Preferably, the present maximum charging power is always limited such that the drive energy store maintains a power consumption reserve, which can be for example 70% to 90%, in particular 80%, of the maximum charging power that is possible without the power consumption reserve.

This power consumption reserve is utilized in particular in order to be able to react quickly to an increase in the braking torque requirement on the part of the driver, without immediately having recourse exclusively to the additional braking device. That also makes it possible, for example, to bridge the relatively sluggish build-up of braking torque by a friction brake and to prevent a delay noticeable to the driver between his/her braking torque requirement and the implementation thereof. The power consumption reserve enables a spontaneous increase in the braking torque requirement to be implemented quickly.

Preferably, the power consumption reserve is re-established as soon as the friction brake completely applies the present additional braking torque. The transition can be made fluid with the charging power being reduced again to the extent to which the braking torque of the friction brake rises.

When determining the present maximum charging power, the power consumption reserve should be taken into account so that the present maximum charging power results from a theoretical present maximum charging power minus the power consumption reserve.

All the parameters are considered in each case at a present point in time, the present braking intention being queried at regular, predefined, short time intervals, for example. Accordingly, the remaining data and parameters are also preferably detected, determined and/or calculated at these time intervals.

In particular, the presently required braking torque, the present maximum charging power of the drive energy store and the present maximum power loss are thus detected at predefined time intervals.

The current generated by the electrical drive motor is considered here approximately as proportional to the braking torque of the electrical drive motor.

By way of corresponding control, preferably effected by a control unit in the onboard system, it is possible for part of the current generated by the electrical drive motor during the braking process to be converted into heat already in the electrical drive motor itself as a result of an increase in the electrical resistance, and thus to be dissipated as power loss. The charging current fed to the drive energy store thus decreases by this portion of the generated current. In this case, the efficiency of the electrical drive motor is reduced in order to generate as much heat loss as possible, contrary to the normal procedure.

If the electrical drive motor has a cooling system, then the latter can be used to dissipate a maximum proportion of the heat loss that arises.

A limiting factor that influences the determination of the present maximum power loss is thus also the present ability of the overall system to take up the heat loss.

It is also possible to generate power loss in power electronics of the drive system by means of the efficiency being reduced by way of corresponding control by the control unit, heat loss arising in the components of the power electronics.

If the power electronics are cooled, then a maximum proportion of the heat loss that arises can be taken up by this cooling.

The onboard system comprises for example the entire drive system without the electrical drive motor and optionally also a low-voltage system which is present in the vehicle and which supplies the remaining consumers on board.

The drive system comprises for example power electronics and optionally an inverter or a DC/DC conversion device, while the low-voltage system can comprise a dedicated low-voltage energy store.

In the onboard system, a power loss can be attained both by means of a reduction of the efficiency of different components, for example power electronics, and by means of an increased power consumption of specific components, for example by means of the turn-on of consumers.

The present maximum power loss can thus also be influenced by a present maximum power consumption of a low-voltage store, which is provided in addition to the drive energy store and is fed from the drive energy store.

In order to increase the present maximum power loss, for example, a charging voltage of the low-voltage store can be increased to a present maximum. The present maximum is dependent on the state of charge of the low-voltage store, inter alia. Moreover, it is possible, for a short period of time, to switch on suitable consumers that are supplied by the low-voltage store in order to draw as much charge as possible from the low-voltage store.

Moreover, it is conceivable, in order to increase the present maximum power loss, to turn on a cooled power resistor which is electrically connected to the drive energy store and in which electrical energy is converted into heat.

By way of example, a friction brake and/or an eddy current brake can be used as additional braking device. If a plurality of additional braking devices are provided, it is conceivable to use them individually or jointly depending on the situation.

The additional braking device is generally independent of the electrical drive motor and can be used independently thereof.

In particular, a hydraulic brake of an ABS device, usually on the front wheel of the motorcycle, or an electromechanical parking brake can be used as additional braking device.

If an electromechanical parking brake is used, then this is preferably already controlled as soon as a value different than zero is present for the present additional braking torque, in which case, as described above, a power consumption reserve can also be used in order initially to increase the charging power and to supply part of the present additional braking torque, since such brakes generally require a longer period of time than a hydraulic friction brake, for example, to fully manifest their braking effect.

A hydraulic friction brake, in particular that of the ABS device, can optionally also be controlled only at a point in time when the majority of the kinetic energy has already been reduced by the electrical drive motor, such that it is used e.g. only at low vehicle speeds.

If an eddy current brake is used as additional braking device, then this can be arranged e.g. on a brake disk of the hydraulic or electromechanical brake in order to reduce the number of component parts required.

It would also be conceivable to use a rotating body in the drive system of the electrical drive motor, for example a transmission, for the induction of eddy currents and to use it as an eddy current brake. An eddy current brake can also be arranged e.g. on a disk secured to the drivetrain.

The use of an eddy current brake is firstly advantageous since the latter directly converts electrical energy and thus contributes to the power loss. Secondly, the efficiency of eddy current brakes is high particularly at high vehicle speeds, i.e. in situations in which the electrical drive motor produces a high recuperation power and the probability of the braking power of the additional braking device being required is high. The eddy current brake is therefore preferably already controlled as soon as a value different than zero is present for the present additional braking torque and the vehicle speed is still relatively high.

If a further braking device is also present besides an eddy current brake, it is particularly advantageous, in most situations in which the use of the additional braking device becomes necessary, exclusively to actuate the eddy current brake in order to minimize abrasion and wear and, only in the cases in which a further, increased braking effect is also required, additionally to use the further braking device, for example the hydraulic brake or the electromechanical brake, in order to apply the remaining braking torque.

In general, it is possible for at least one driven wheel of the motorcycle always to be braked exclusively without the use of an additional friction brake, such that for example the driven rear wheel can be designed completely without a friction brake. In general, the rear wheel of the motorcycle is the sole driven wheel.

By contrast, the additional braking device is preferably arranged on the non-driven wheel of the motorcycle.

An electrically driven motorcycle with which one of the methods mentioned above can be carried out comprises a drive energy store, an onboard electrical system connected to the drive energy store, an electrical drive motor that is usable as a generator, at least one additional braking device that is separate from the electrical drive motor, and a control unit designed to implement the corresponding method steps.

In the context of this application, the term “motorcycle” is understood to mean both a traditional, two-wheeled, single-track motorbike, which can also be a motor scooter, and e.g. a three-wheeled single-track vehicle.

The control unit is generally connected to various sensors that make it possible for example to detect the presently required braking torque, the present maximum charging power and the present state of charge of the drive energy store and, optionally, of the low-voltage store, and also to determine the present maximum power loss that is generable. Temperature sensors on the individual components or in a cooling system can also be connected to the control unit in order to supply data that influence the determination of the individual parameters.

It is also possible additionally to detect the vehicle speed and a roadway inclination, if appropriate, which have an influence on the maximum kinetic energy to be reduced overall and thus the maximum current generated overall by the electrical drive motor.

The control unit can comprise a motor controller and an ABS controller, for example.

The invention is described in greater detail below on the basis of an exemplary embodiment illustrated in the sole FIGURE.

### BRIEF DESCRIPTION OF THE DRAWING

FIG. 1 shows a schematic illustration of an electrically driven motorcycle according to the present disclosure with which the method according to the present disclosure for braking the motorcycle can be carried out.

### DETAILED DESCRIPTION OF THE DRAWING

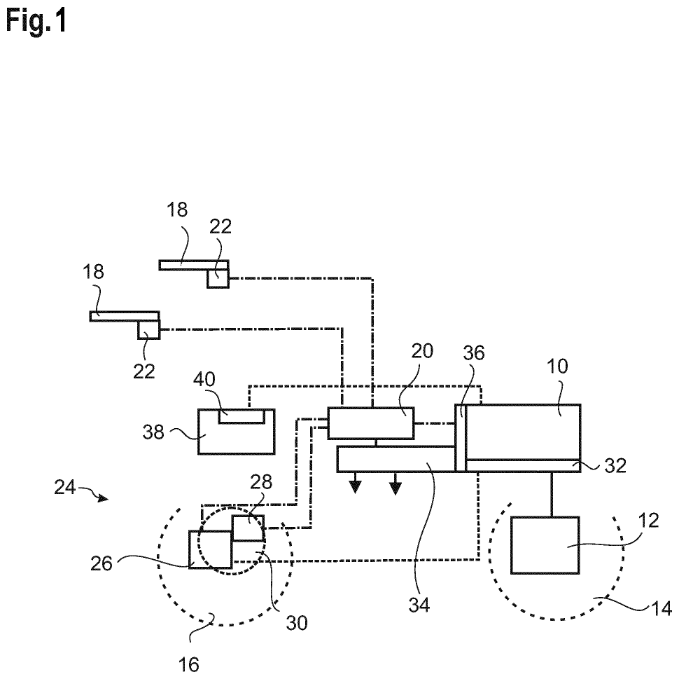

FIG. 1 schematically shows system components of an electrically driven motorcycle, not illustrated in more specific detail, which form part of a drive system and an onboard system, inter alia.

The drive energy originates completely from a drive energy store 10, also referred to as a traction battery, which moves a driven wheel 14 by way of one or more electrical drive motors 12. In this example, the driven wheel 14 is the rear wheel of the motorcycle. By contrast, in this example, the wheel 16, here the front wheel, is not driven and therefore does not have a dedicated electrical drive motor.

If the motorcycle is intended to be braked, the driver actuates one or both brake levers 18, respectively assigned to the front wheel 16 and the rear wheel 14.

During every braking process, the main braking power is produced by the electrical drive motor 12, which in this case is used as a generator and thus generates a torque that brakes the driven wheel 14 and thus the vehicle.

The drive energy store 10 is of such powerful design here that its capacity and its charging power density, i.e. the charging power per vehicle mass, are designed with a magnitude such that given sufficient free charging capacity, in all normal driving states, in principle, the current generated by means of braking by means of the electrical drive motor 12 can be taken up in the drive energy store 10.

By way of example, the drive energy store 10 has a capacity of 20 kWh, and a maximum recuperation power of the drive motor 12 is e.g. 60 kW.

Therefore, in this example, no friction brake is arranged on the driven wheel 14.

The brake levers 18 are electronically connected to a control unit 20; there is no direct mechanical connection to a braking device here. In order to detect the braking intention, a sensor 22 connected to the control unit 20 is arranged on each brake lever 18.

At short, predefined time intervals Δt, a query is raised as to whether there is a braking intention with a presently required braking torque that is different than zero.

In this example, the data for the actuation of the right and left brake levers 18 are both computed in the control unit 20 to form a single presently required braking torque, which is applied in the subsequent braking process without differentiation of the origin.

An additional braking device 24, which in this example consists of a hydraulic brake of an ABS device 26, an electromechanical parking brake 28 and/or an eddy current brake 30, is arranged here on the non-driven wheel 16. In this example, the eddy current brake 30 is arranged on a disk brake of the hydraulic brake of the ABS device 26.

The electromechanical parking brake 28 is for example a distance-controlled brake that is actuated by a dedicated electric motor that is completely separate from the electrical drive motor 12.

The drive energy store 10 is connected to the electrical drive motor 12 via power electronics 32, wherein in general current flows between the drive energy store 10 and the electrical drive motor 12 through the power electronics 32.

Moreover, a low-voltage energy store 34 is provided here, which is fed from the (high-voltage) drive energy store 10 via a DC/DC converter 36 and which supplies the remaining electrical consumers on the vehicle (indicated by the arrows in the FIGURE).

Optionally, a power resistor 40 can be arranged in a cooling system 38 (for example air cooling), and is connected to the drive energy store 10.

If a braking intention on the part of a driver is detected by virtue of the sensors 22 at the brake levers 18 signaling a corresponding signal to the control unit 20, then the control unit detects a present state of charge of the drive energy store 10 and determines a present maximum charging power of the drive energy store 10.

Moreover, the control unit 20 acquires further data from further sensors (not illustrated) e.g. concerning the vehicle speed, system temperature or a roadway inclination.

From the present braking intention and optionally additional parameters of this type, the control unit 20 calculates a presently required braking torque.

In addition, the control unit determines a present maximum power loss that is generable in the electrical drive motor 12 and/or in the onboard electrical system. This present maximum power loss results from possible power losses of all the components of the system in which electrical energy can be consumed and, in particular, converted into heat.

This includes control of the electrical drive motor 12 with a poorer efficiency than the optimum efficiency, wherein a greater part of the mechanical braking power generated during generator operation is transformed into electrical power loss and converted into heat within the electrical drive motor 12.

Moreover, the power electronics 32 can be controlled with a poorer efficiency, such that an increased electrical resistance occurs here, too, which likewise results in heat loss.

A further option is to transfer electrical energy from the drive energy store 10 into the low-voltage energy store 34, wherein here the highest possible charging voltage is applied in order, in the shortest possible time, to dissipate the largest possible quantity of charge from the drive energy store 10 and thus to create charging capacity for the current supplied by the electrical drive motor 12.

Moreover, all suitable consumers connected to the low-voltage energy store 34 can be switched on or operated at a high level in order additionally to consume electrical energy from the low-voltage energy store 34 and thus to create free charging capacity in the low-voltage energy store 34.

Optionally, the power resistor 40 in the cooling system 38 can be turned on in order, in a targeted manner, to convert further electrical energy into heat energy and thus to consume current.

From all these parameters, the control unit 20 calculates a present maximum power loss by which it is possible at most to reduce the maximum recuperation power of the electrical drive motor 12 for the presently required braking torque.

From these values, the control unit 20 determines a present additional braking torque that is to be applied by the additional braking device 24. This present additional braking torque results from a difference between the presently required braking torque and a braking torque resulting from the present maximum charging power and the present maximum power loss that can be applied.

If the presently required braking torque can be applied exclusively using the electrical drive motor 12 during generator operation at optimum efficiency, without the present maximum charging power of the drive energy store 10 being exceeded, then the braking process is carried out exclusively in this way.

The presently required power loss and the present additional braking torque are both equal to zero in this case. Consequently, the efficiency of the electrical drive motor 12 is not reduced, nor is a braking torque applied by the additional braking device 24, rather the maximum possible energy is recuperated by the braking process.

By contrast, if the control unit 20 ascertains that it is not possible to apply the presently required braking torque with the present maximum charging power of the drive energy store 10, then it determines a presently required power loss resulting from the difference between the present maximum charging power and a maximum recuperation power of the electrical drive motor 12 for the presently required braking torque.

The control unit 20 increases the overall power loss in the system by virtue of the fact that, as described above, the control unit reduces the efficiency of the electrical drive motor 12 during generator operation and also, optionally, of the power electronics 32 and of other electronic components, charges the low-voltage energy store 34 with maximum charging voltage, turns on consumers and/or optionally energizes the power resistor 40 and thus converts current supplied by the electrical drive motor 12 into heat.

The control unit 20 here selects suitable measures of suitable intensity for setting the presently required power loss.

If the control unit 20 ascertains that the presently required power loss exceeds the present maximum power loss, then in order to reduce the remaining braking torque, the present additional braking torque is set to the residual value and the additional braking device 24 is actuated until the remaining braking torque has been reduced and the braking intention has been fulfilled.

Here, preferably, the eddy current brake 30 is actuated first since it likewise reduces electrical energy and thus also directly increases the power loss.

It is only if the additional braking torque is so high that the eddy current brake 30 cannot apply this by itself that the hydraulic brake of the ABS device 26 and/or the electromechanical parking brake 28 are/is turned on.

In systems in which there is no eddy current brake, some other additional braking device 24 is controlled directly, of course.

In this example, the present maximum charging power is limited by a power consumption reserve of the drive energy store 10, which is for example 70% to 90%, here 80%, of the actual maximum charging power.

In this example, this power consumption reserve is utilized in order already to react quickly to an increase in the braking torque intention on the part of the driver before the additional braking device 24, in particular the parking brake 28, manifests its full braking effect after it has been controlled. In this regard, the build-up of braking torque by the friction brake is bridged, the power consumption reserve being re-established as soon as the additional braking device 24 completely applies the present additional braking torque. In this case, the charging power is reduced to the extent to which the braking torque of the additional braking device 24 rises.

The present maximum charging power is therefore defined here from a theoretical present maximum charging power, which is influenced by all present relevant parameters concerning the drive energy store 10, minus the power consumption reserve.

The detection of the parameters and also the calculation and determination of the individual magnitudes in the control unit 20 are always effected here at a present point in time ta, beginning in each case after the interval Δt has elapsed, at which the magnitude of the presently required braking torque is once again queried.

The method according to the present disclosure makes it possible, in a multistage process, to reliably implement every braking intention, it likewise being ensured that braking energy is recuperated with optimum efficiency.

1-10. (canceled)

11. A method for braking an electrically driven motorcycle comprising a drive energy store, an onboard electrical system connected to the drive energy store, an electrical drive motor that is usable as a generator, and at least one additional braking device that is separate from the electrical drive motor, the method comprising:
detecting a braking intention with a presently required braking torque;
determining a present maximum charging power of the drive energy store;
determining a present maximum power loss that is generable in the electrical drive motor and/or in the onboard electrical system;
determining a presently required power loss resulting from a difference between the present maximum charging power and a maximum recuperation power of the electrical drive motor for the presently required braking torque;
determining a present additional braking torque that is to be applied by the additional braking device from a difference between the presently required braking torque and a braking torque of the electrical drive motor resulting from the present maximum charging power and the present maximum power loss that can be applied;
controlling the electrical drive motor and/or the onboard electrical system with a reduced efficiency such that the presently required power loss is attained; and
actuating the additional braking device such that the present additional braking torque is applied by the additional braking device.

12. The method according to claim 11, comprising:
detecting the presently required braking torque, the present maximum charging power of the drive energy store, and the present maximum power loss at predefined time intervals.

13. The method according to claim 11, comprising:
limiting the present maximum charging power according to a predefined power consumption reserve.

14. The method according to claim 11, wherein the present maximum power loss is influenced by a present maximum power consumption of a low-voltage energy store, which is provided in addition to the drive energy store and is fed from the drive energy store.

15. The method according to claim 14, wherein in order to increase the present maximum power loss, a charging voltage of the low-voltage energy store is increased to a present maximum.

16. The method according to claim 11, comprising:
using a friction brake and/or an eddy current brake as the additional braking device.

17. The method according to claim 16, comprising:
using a hydraulic brake of an anti-lock braking system (ABS) device or an electromechanical parking brake as the additional braking device.

18. The method according to claim 16, wherein the eddy current brake is arranged on a brake disk of a hydraulic or electromechanical brake, and/or a rotating body in the drive system of the electrical drive motor is used for induction of eddy currents and is used as the eddy current brake.

19. The method according to claim 11, comprising:
braking at least one driven wheel of the motorcycle exclusively without the use of the additional friction brake.

20. An electrically driven motorcycle comprising:
a drive energy store;
an onboard electrical system connected to the drive energy store;
an electrical drive motor that is usable as a generator;
at least one additional braking device that is separate from the electrical drive motor; and
a control unit configured to:
detect a braking intention with a presently required braking torque;
determine a present maximum charging power of the drive energy store;
determine a present maximum power loss that is generable in the electrical drive motor and/or in the onboard electrical system;
determine a presently required power loss resulting from a difference between the present maximum charging power and a maximum recuperation power of the electrical drive motor for the presently required braking torque;
determine a present additional braking torque that is to be applied by the additional braking device from a difference between the presently required braking torque and a braking torque of the electrical drive motor resulting from the present maximum charging power and the present maximum power loss that can be applied;
control the electrical drive motor and/or the onboard electrical system with a reduced efficiency such that the presently required power loss is attained; and
actuate the additional braking device such that the present additional braking torque is applied by the additional braking device.

21. The electrically driven motorcycle according to claim 20,
wherein the control unit is configured to:
detect the presently required braking torque, the present maximum charging power of the drive energy store, and the present maximum power loss at predefined time intervals.

22. The electrically driven motorcycle according to claim 20,
wherein the control unit is configured to:
limit the present maximum charging power according to a predefined power consumption reserve.

23. The electrically driven motorcycle according to claim 20,
wherein the present maximum power loss is influenced by a present maximum power consumption of a low-voltage energy store, which is provided in addition to the drive energy store and is fed from the drive energy store.

24. The electrically driven motorcycle according to claim 23,
wherein in order to increase the present maximum power loss, a charging voltage of the low-voltage energy store is increased to a present maximum.

25. The electrically driven motorcycle according to claim 20,
wherein the additional braking device comprises a friction brake and/or an eddy current brake.

26. The electrically driven motorcycle according to claim 25,
wherein the additional braking device comprises a hydraulic brake of an anti-lock braking system (ABS) device or an electromechanical parking brake.

27. The electrically driven motorcycle according to claim 25,
wherein the eddy current brake is arranged on a brake disk of a hydraulic or electromechanical brake, and/or a rotating body in the drive system of the electrical drive motor is used for induction of eddy currents and is used as the eddy current brake.

28. The electrically driven motorcycle according to claim 20,
wherein the control unit is configured to:
brake at least one driven wheel of the motorcycle exclusively without the use of the additional friction brake.
